(19) United States
(12) Patent Application Publication
(10) Pub. No.: US 2003/0052999 A1
(43) Pub. Date: Mar. 20, 2003

(54) Method and apparatus for a news and music video feed

(76) Inventor: Matthew Alan Weber, Winter Springs, FL (US)

Correspondence Address: MCKEE, VOORHEES & SEASE, P.L.C., 801 GRAND AVENUE, SUITE 3200, DES MOINES, IA, 50309-2721, US

(21) Appl. No.: 09/952,818

(22) Filed: Sep. 14, 2001

(51) Int. Cl. H04N 5/445; H04N 5/45

(52) U.S. Cl. 348/564; 348/565

(57) ABSTRACT

The present invention is a method of providing a news and music video feed. The method includes dividing a display into a plurality of regions, displaying a music video in a music video region of the display, simultaneously displaying news information in a news region of the display while displaying the music video, the music video region is substantially free of overlap with the news region, and broadcasting a signal representing the display. The apparatus of the invention includes a frame of video displaying information having a music video area containing a music video frame and a news area containing textual news information, the music video area separated from the news area.

### BACKGROUND OF THE INVENTION

The present invention relates to broadcasting. In particular, the present invention relates to simultaneously broadcasting a music video and news information.

Video broadcasts have long been used to provide news and other information to viewers. One of the inherent problems of delivering news information via broadcast is that viewers seeking specific news items are held hostage until the broadcast displays or otherwise communicates the viewer desired information. In broadcast mediums, as opposed to interactive mediums, the viewer can not control what information is displayed on a particular broadcast, but only whether or not to watch the broadcast.

A viewer normally does not desire to watch a television broadcast for a long period of time while waiting for an information item of interest to be broadcast. For example, a viewer may not desire to watch the whole of the evening news just to see the weather prediction for the next day.

In order to accommodate those that seek information items, broadcasters can periodically broadcast information believed to be of wider interest or more universal appeal. This information may be displayed in text format. For example, weather information and sports scores are types of information that are periodically displayed as a part of a broadcast. Often this information is overlayed over a regular broadcast. The information may involve either static or dynamic text and images. Static text is merely stationary text. An example of dynamic text is a ticker that scrolls information across the screen. News, weather, or other information may be periodically displayed through static and/or dynamic text and images.

Although these prior art attempts have provided for broadcasting information items, problems remain. Where information is merely overlayed on a regular broadcast, a portion of the regular broadcast is obstructed from view. A viewer interested in the regular broadcast and not the overlayed informational items may consider this an annoying interruption of their viewing experience, detracting from the entertainment value of the broadcast.

Other problems occur when the information is displayed full screen during breaks in regular programming. One problem is accommodating different groups of viewers. One group of viewers may be interested in seeing news items, weather, or other information broadcast on a periodic basis. It is desirable for viewers to tune in having the expectation that if they watch long enough, these informational items will be displayed. At the same time, other viewers may be more interested in watching their regular programming and have no interest in viewing these informational items but would rather be entertained. If these informational items are presented and have no entertainment value, the viewer may switch channels and not return, or turn the television off.

Even those who are interested in news items may not necessarily all be interested in the same types of information. For example, some viewers may be interested in sporting news or entertainment news but not business news.

Therefore, there is a real need in the art for an improvement related to the provision of informational services within broadcasts. It is therefore a principal object of the present invention to provide a method and apparatus that improves over or solves the problems and deficiencies in the art.

Another object of the present invention is to provide an apparatus and method that is capable of providing textual information such as news.

Another object of the present invention is to provide an apparatus and method that is capable of providing a broadcast addition that encourages viewers to tune in to catch information that is important to them.

It is a further object of the present invention to provide a broadcast programming service that provides for informational dissemination while providing entertainment.

A further object of the present invention is to provide for a broadcast programming service that provides period news updates without interfering with regular programming.

These and other objects, features, and advantages of the present invention will become more apparent with reference to the accompanying specification.

### BRIEF SUMMARY OF THE INVENTION

The invention is a method and apparatus for combining text based news information with music videos. A display may be divided into a number of different regions. One region contains a music video display. While the music video is being displayed, textual news information is also displayed. This provides viewers with the option of focusing on the music video or focusing on the news item. The present invention also provides for multiple news items to be simultaneously displayed, such as through multiple tickers. In addition, weather information, the time, or other informational items may be added. This allows a viewer to focus on one or more of these informational items as well as the music video.

The present invention encourages viewers to be drawn to view broadcasts in order to catch a periodic display of information such as news, weather, or other desirable information. At the same time, the invention provides for maintaining the entertainment value of the broadcast by displaying a music video in addition to the informational items.

### BRIEF DESCRIPTION OF THE DRAWINGS

FIG. 1 is a diagram showing a video display according to the present invention.

FIG. 2 is a block diagram illustrating a system for producing a broadcast containing a display according to the present invention.

### DETAILED DESCRIPTION OF THE INVENTION

The present invention relates to simultaneously displaying informational items and a music video in the same broadcast.

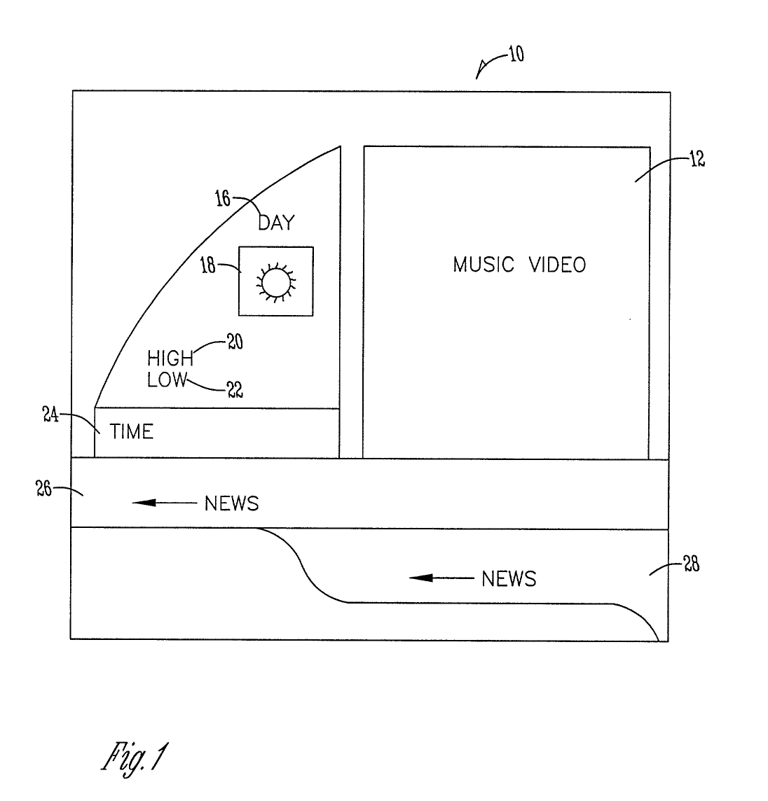

FIG. 1 is a diagram showing a video display 10 according to the present invention. In FIG. 1, a music video 12 is displayed. As shown in FIG. 1, the music video 12 is unobstructed by the other elements of the video display 10. In addition, the video display 10 provides for informational content. For example, information content related to current weather conditions or weather forecasts can be shown. The day 16 can correspond to the current day or a future day such as “tomorrow” or to a particular day of the week. The corresponding weather forecast is also given. The weather forecast can be represented by a symbol 18 corresponding to a weather condition. For example ,the symbol 18 can be a sun corresponding to sunny weather, a cloud corresponding to cloudy weather, or other widely accepted symbols may be used such as are known in the art. In addition, a high temperature 20 and a low temperature 22 are also displayed to correspond with the forecasted high temperature 20 and low temperature 22 of the day 16. The information content on the video display 10 can also include the current time 24.

The video display 10 also includes one or more news items. The news items may be static text or dynamic text. Where dynamic text is used, methods such as rolls, and crawls may be used. News item 26 is a news item that crawls across the video display 10 over time in ticker fashion. Additional news items may also be used, such as news item 28 that crawls across the video display 10 in ticker fashion.

Preferably, when multiple regions of news items are used, each region of news contains a different type of news. For example, local news can be displayed in one news region while entertainment news is displayed in a second news region. Similarly, national news may be displayed in one news item while sporting news is displayed in another news item. When multiple news items are used, the viewer is provided with additional choices to focus on. The present invention further provides for other types of informational items to be broadcast including advertising information.

According to the present invention, both music video and informational items are simultaneously presented such that a viewer has their choice of focusing on the music video or on informational items such as news or weather. Because the music videos provide entertainment value to the video feed, the length of time the video feed can be broadcast can be longer in length than if there were no music videos. This allows a greater period in which to display informational items, providing an additional advantage over the prior art.

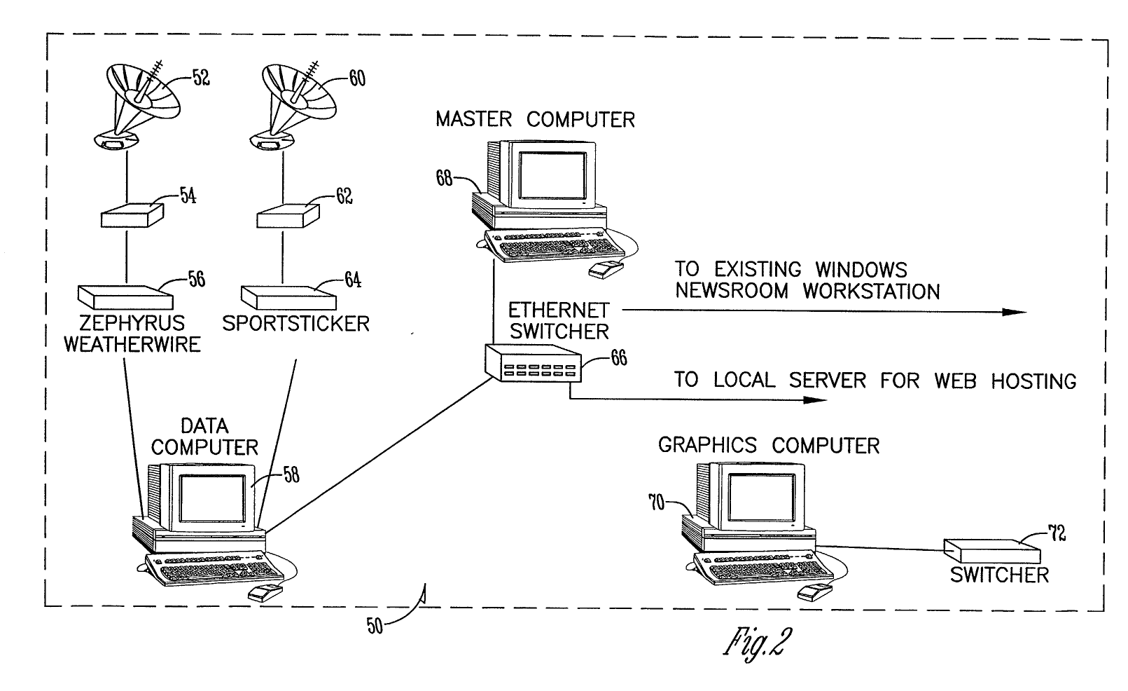

The video display can be created in a number of ways including that shown in FIG. 2. FIG. 2 illustrates one system capable of producing the video display of the present invention. In FIG. 2, an antenna or satellite dish 52 is used to receive weather information from a service such as the National Weather Services Emergency Managers Weather Information Network (EMWIN). Such a system is available from companies such as Zephyrus Electronics of Tulsa, Oklahoma. The system may have a receiver with an outside portion 54 and an inside portion 56. This type of system allows the weather information to be received by a computer 58.

Similarly, the computer 58 can receive other types of information from other types of informational services. For example, services provided by Sports Ticker, Inc. of Scarsdale, New York or other informational service can provide these services. Such a service may be by satellite 60 as shown with outdoor receiver portion 62 and indoor receiver portion 64, or else may be through a wire service as well. The data computer 58 is electrically connected to the sports information feed 64 as shown in FIG. 2. The data computer 58 is electrically connected to a network such as to an Internet network through Ethernet Switchers 66.

A master computer 68 may also be electrically connected to the network through the Ethernet Switcher 66. The master computer may be configured to handle incoming information from the data computer 58. The master computer 68 also schedules information for transmission and holds setup information on how each individual alert behaves on the air. The master computer maintains all hardware setup and control information. The master computer 68 makes all editing and transmission controls alerts available to station personnel. The master computer 68 controls automatic and/or manual control preferences for the entire system.

A graphics computer 70 is also electrically connected to the network through Ethernet Switchers 66. The graphics computer 70 handles commands from the master computer 68. The graphics computer 70 can control a character generator, digital video editing equipment's (DVE's) background graphics display, video switching devices, and/or other video devices. The video switching device 72 is shown electrically connected to the graphics computer 70.

The system hardware shown in FIG. 2 is merely one example of the setup that can be used to implement the present invention within the television broadcast environment. The present invention allows for other implementations for other types of broadcast environments. The resulting image or display according to the invention may be broadcast in any number of formats, including television compatible formats such as the National Television Standards Committee (NTSC) format, phase alternating line (PAL) format, or a digital television format.

Thus a method and system for news and music video feed has been described by the advantages to broadcasters who use it and viewers who watch it. The present invention contemplates numerous variations in the format and displays of information, the type of broadcasting, and the type of implementation of the display as well as other variations. The present invention is limited only by the claims appended hereto.

What is claimed is:

1. A method of providing a news and music video feed comprising:
dividing a display into a plurality of regions;
displaying a music video in a music video region of the display;
simultaneously displaying news information in a news region of the display while displaying the music video;
the music video region is substantially free of overlap with the news region; and
broadcasting a signal representing the display.

2. The method of claim 1 further comprising simultaneously displaying weather information in a weather region of the display while displaying the music video.

3. The method of claim 1 further comprising simultaneously displaying news information in a second news region of the display while displaying the music video.

4. The method of claim 1 further comprising simultaneously displaying traffic information in a traffic region of the display while displaying the music video.

5. The method of claim 1 wherein the news information is static text.

6. The method of claim 1 wherein the news information is dynamic text.

7. The method of claim 1 further comprising simultaneously displaying time information in a time region of the display while displaying the music video.

8. The method of claim 1 wherein the signal is a television signal.

9. A frame of video display information comprising:
a music video area containing a music video frame; and
a news area containing textual news information, the music video area separated from the news area.

10. The frame of claim 9 further comprising a weather area containing weather information.

11. The frame of claim 9 further comprising a second news area containing textual news information.

12. The frame of claim 9 wherein the textual news information is sporting news.

13. The frame of claim 9 wherein the textual news information is traffic news.
